(19) United States
(12) Patent Application Publication
(10) Pub. No.: US 2012/0033813 A1
(43) Pub. Date: Feb. 9, 2012

(54) Method of Selective Protection of the Satellite Rebroadcasting of Data Broadcast Publicly and Collected by the Satellite

(75) Inventor: Thibaud Calmettes, Ville (FR)

(73) Assignee: THALES, Neuilly-sur-Seine (FR)

(21) Appl. No.: 13/123,418

(22) PCT Filed: Oct. 12, 2009
(86) PCT No.: PCT/EP09/63294

§ 371 Date: May 2, 2011

(30) Foreign Application Priority Data
Oct. 10, 2008 (FR) 08 05613

(51) Int. Cl. H04K 1/02

(52) U.S. Cl. 380/270

(57) ABSTRACT

The AIS (Automatic Identification System) is a communication system between ships, for example fishing boats, which is used to limit collisions between these ships and that allows maritime traffic in sight of the coasts to be monitored by virtue of coastal stations that listen to the communications. The collection by satellite of these data allows for maritime monitoring far from the coasts and allows the data transmitted to be checked by analysis of the received signal. The maritime monitoring authorities do not want the data concerning, for example, the position of the ships in their territorial waters, collected by satellite, to be broadcast globally. This is because this would enable a user, by listening to the satellite, to know the AIS messages exchanged far from these coasts. The AIS messages contain the position of the transmitting ship, and its identifier, its direction, etc. The invention consists in putting in place an encryption of the data returned from the satellite based on the content of these data. The encryption of the data also enables the authorities to supply the AIS data as a service, possibly a paying service.

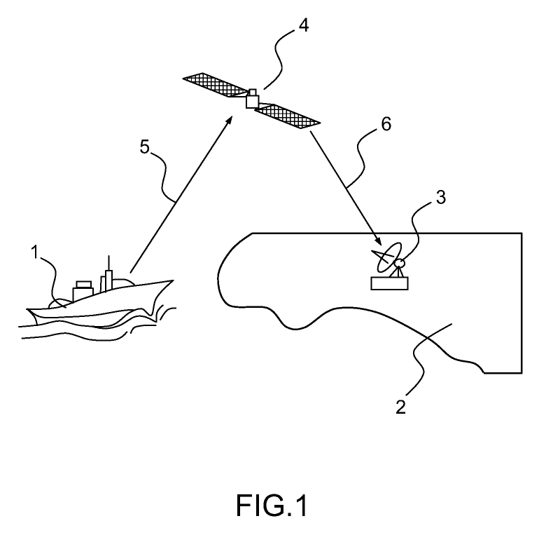

The present invention relates to a method for selectively protecting the satellite rebroadcasting of data broadcast publicly and collected by the satellite. This invention is proposed in the context of the satellite collection of AIS data. It applies only to the applications in which the signal transmitted from the Earth and collected by the satellite is public.

The AIS (Automatic Identification System) is a public communication system between ships which makes it possible to limit the collisions between ships and that enables maritime traffic in sight of the coasts to be monitored by virtue of coastal stations that listen to the communications. The satellite collection of these data allows for maritime monitoring far from the coasts and enables the transmitted data to be checked by analysis of the received signal. The AIS messages, which are broadcast publicly, contain the position of the transmitting ship, and its identifier, its heading, its speed, etc.

The maritime monitoring authorities do not generally want the data concerning, for example, the position of the ships in their territorial waters, collected by satellite, to be broadcast globally. This is because this would enable a user, possibly ill-intentioned, by listening to the satellite, to know the AIS messages exchanged far from its coasts.

Furthermore, said authorities may want to provide services, possibly paying services, to certain categories of ships, which the current methods do not allow, provided that the final client has the means for receiving the data retransmitted by the satellite.

Also, the use of a single encryption is such that a user has access to all (including the data from the ships located in the territorial waters of other countries) or nothing (including the data from the ships not located in his territorial waters), so that if he wants to have access to the data from the ships located in his territorial waters, all the authorized users must also have access thereto.

The subject of the present invention is a method for selectively protecting the satellite rebroadcasting of data broadcast publicly and collected by the satellite, so that some of these data can be accessible only to authorized persons or entities.

The method according to the invention is a method for selectively protecting the satellite rebroadcasting of data broadcast publicly from the ground, collected by the satellite, and rebroadcast by the satellite to the ground, and it is characterized in that it consists in encrypting, on board the satellite before rebroadcasting to the ground, according to at least one encryption level, a portion of the data, the encryption key used for this encryption being a function of the data themselves. According to one aspect of the invention, the data collected and rebroadcast by the satellite are AIS data.

According to another characteristic of the invention, this method is characterized in that the encryption is a function of the position of the initial transmitter on the ground, said position being contained in the data stream transmitted by the ground transmitter, collected by the satellite, encrypted on board the satellite, then rebroadcast to the ground by the satellite.

According to yet another characteristic of the invention, this method is characterized in that the encryption is a function of the identity of the initial transmitter on the ground, said identity being contained in the data stream transmitted by the ground transmitter, collected by the satellite, encrypted on board the satellite, then rebroadcast to the ground by the satellite.

According to another characteristic of the invention, relating to the AIS data, the broadcast data may be accessible to a given authority of a given country if at least one of the following conditions is satisfied: the ship is of the same nationality as these authorities, or the ship is in its territorial waters, or the ship's destination is a port of the given country and said ship is close to its final destination.

The invention consists in particular in putting in place an encryption of the data of the downlink channel from a telecommunications satellite based on the content of these data, for example, to make only the data concerning the ships present in its territorial waters accessible to an authority.

The encryption of the data may also enable the authorities to provide the AIS data concerning their territorial waters as a service, possibly a paying service, and possibly a service with selective availability.

The present invention will be better understood from reading the detailed description of an embodiment, taken as a nonlimiting example and illustrated by the appended drawing in which:

the single FIGURE is a simplified diagram of the means implemented for an application of the invention to the AIS system.

The diagram of the single FIGURE of the drawing shows a ship 1 navigating off the coasts of a country 2. A terrestrial communication station 3 with at least one satellite 4 dealing with an AIS system is located in the country 2, at any distance from the coasts, the condition being that it can communicate with the satellite 4, possibly in batch mode. The ship 1 (like all the ships participating in the AIS system concerned) transmits toward the satellite 4 an “uplink” AIS data beam 5, and this satellite retransmits, possibly in batch mode, toward the station 3, a “downlink” AIS beam 6 of data processed as described below. We will not describe here in detail the “return” path of the AIS communications, namely the various instructions and information items transmitted by the station 3 toward the satellite 4. Simply the fact that the station 3 can send to the transmission equipment of the satellite 4 orders to modify the encryption performed on board and falling within the competence of the authorities managing the station 3 will be mentioned.

The AIS processing performed on board the satellite 4 is as follows. The country 2 has access to the data transmitted by the ship 1, for example if:
the ship 1 is of the same nationality
or the ship 1 is in its territorial waters
or the ship 1 is heading for a port of the country 2 and is fairly close to its final destination.

The way in which the encryption enabling this conditional access is performed is evident to those skilled in the art from reading the present description, this encryption possibly being of known type, for example of the type implemented for banking transactions. Advantageously, each authority directly downloads, on board the satellite, the encryption key that it wants to use, so that the designer of the satellite does not know it.

According to an advantageous variant of the invention, an authority authorized to manage the encryption determines a multiple-level encryption, as a function of the grade of the various users who can receive the data broadcast by the AIS system. Advantageously, the authority communicates, directly to the satellite, an encryption that it wants the satellite to use to broadcast the data that are intended for it. For example, France may authorize all the other countries to access the data concerning a list of ships, may authorize only the countries of the EU to access the data concerning another list of ships, and retain unique rights to a final list. In this case, the downlink message to the ships is coded as many times as there are lists.

1. A method for selectively protecting the satellite rebroadcasting of data broadcast publicly from the ground, collected by the satellite, and rebroadcast by the satellite to the ground, comprising:
encrypting, on board the satellite before rebroadcasting to the ground, according to at least one encryption level, a portion of the data, the encryption key used for this encryption being a function of the data themselves.

2. The method as claimed in claim 1, wherein the encryption is a function of the position of the initial transmitter on the ground, said position being contained in the data stream transmitted by the ground transmitter, collected by the satellite, encrypted on board the satellite, then rebroadcast to the ground by the satellite.

3. The method as claimed in claim 1, wherein the encryption is a function of the identity of the initial transmitter on the ground, said identity being contained in the data stream transmitted by the ground transmitter, collected by the satellite, encrypted on board the satellite, then rebroadcast to the ground by the satellite.

4. The method as claimed in claim 1, wherein the data collected and rebroadcast by the satellite are AIS communication data for ships.

5. The method as claimed in claim 4, the broadcast data may be accessible to a given authority of a given country if at least one of the following conditions is satisfied: the ship is of the same nationality as these authorities, or the ship is in its territorial waters, or the ship's destination is a port of the given country and said ship is close to its final destination.

6. The method as claimed in claim 1, wherein the encryption is a multiple-level encryption and that an authority authorized to manage the encryption determines a multiple-level encryption, as a function of the grade of the various users who can receive the data broadcast by the satellite.

7. The method as claimed in claim 6, wherein the authority communicates, directly to the satellite, an encryption that it wants the satellite to use to broadcast the data that are intended for it.

8. The method as claimed in claim 5, wherein the authority communicates, directly to the satellite, an encryption that it wants the satellite to use to broadcast the data that are intended for it.
